(19) United States
(12) Patent Application Publication
(10) Pub. No.: US 2017/0248288 A1
(43) Pub. Date: Aug. 31, 2017

(54) LED DEVICE WITH FLEXIBLE THERMAL INTERFACE

(71) Applicant: KONINKLIJKE PHILIPS N.V., Eindhoven (NL)

(72) Inventors: Rob Bastiaan Maria Einig, Aachen (DE); Astrid Marchewka, Aachen (DE); Nils Benter, Dusseldorf (DE)

(21) Appl. No.: 15/501,052

(22) PCT Filed: Jul. 27, 2015
(86) PCT No.: PCT/EP15/67124

§ 371 Date: Feb. 1, 2017

(30) Foreign Application Priority Data
Aug. 8, 2014 (EP) 14180289.2

(51) Int. Cl. F21S 8/10

(52) U.S. Cl. CPC F21S 48/328; F21S 48/23; F21S 48/215; F21S 48/321; F21Y 2115/10

(57) ABSTRACT

The present invention relates to a LED device at least comprising a LED module with one or several LEDs mounted on a carrier, a heat sink or heat spreader and a thermal interface between the carrier and the heat sink. The carrier is thermally connected via the thermal interface to the heat sink. The thermal interface is formed of a member of a heat-conducting material, which is ductile at least during assembling of the device and allows to arrange the heat sink in orientation and position substantially independent from the carrier. The proposed LED device allows for flexible design solutions of the thermal components as well as the overall design, e. g. for applications in automotive lighting.

### BACKGROUND OF THE INVENTION AND PRIOR ART

The present invention relates to a LED device comprising a LED module with one or several light emitting diodes (LED) mounted on a carrier, a heat sink and a thermal interface between the carrier and the heat sink, said carrier being thermally connected via the thermal interface to the heat sink.

Light emitting diodes are nowadays widely used in automotive lighting. Applications of LED light sources in automotive lamps include low beam and high beam functions, daytime running light, turn indicator and rear combination light. To make maximum use of styling flexibility, automotive LED solutions are often developed individually for each platform, leading to complex integration of the products into the luminaire. The use of LED modules allows for a simple and cost-effective integration of LED light sources. Besides LED functionality, these modules provide interfaces and reference points to be aligned with the thermal and optical components of the device in which they are to be mounted, e.g. a luminaire.

LED modules on a heat spreader or heat sink represent relatively large and rigid devices that have to be aligned with the optics in a luminaire. The position of the heat sink or heat spreader with respect to the LED module is defined by the module's thermal interface. This limits design flexibility and therefore impacts the appearance of the luminaire. This drawback also applies to US 2010/0302777 A1 which discloses a typical LED module with one or several LEDs mounted on a carrier which is thermally connected via a thermal interface to a heat sink. The thermal interface is formed by a heat-conducting adhesive which contains glass spherules in order to maintain a defined small distance between the carrier and the heat sink.

### SUMMARY OF THE INVENTION

It is an object of the present invention to provide a LED device at least comprising a LED module and a heat sink or heat spreader, said LED device allowing a more flexible design.

This object is achieved with the LED device according to claim 1. Advantageous embodiments of the device are subject matter of the dependent claims or are described in the subsequent portions of the description and preferred embodiments.

The proposed LED device at least comprises a LED module with one or several LEDs mounted on a carrier, a heat sink or heat spreader and a thermal interface between the carrier and the heat sink, wherein the carrier is thermally connected via the thermal interface to the heat sink. In the proposed LED device the thermal interface is formed of a member of a heat conducting material, which is ductile at least during assembling of the device and allows to arrange the heat sink or heat spreader in orientation and position substantially independent from the carrier. To this end the member must not only be ductile at the time of assembling the device but must also allow the heat sink or heat spreader to be positioned with an irregular spacing or with an inclination to the carrier, i.e. between the corresponding surfaces of the carrier and the heat sink or heat spreader, and correspondingly also at a larger distance from the carrier than is possible with an adhesive of the prior art.

Such a LED device allows the heat sink or heat spreader to be positioned and oriented nearly independent from the position and orientation of the module, only dependent on the individual application and the spatial conditions of this application. The positioning of the heat sink or heat spreader versus the carrier of the LED module is not defined by the module, but can be adjusted individually. This allows for flexible design solutions of the thermal components as well as the overall design. The heat sink or heat spreader alignment is separated from the mechanical referencing of the optical system of the application to the LED module, thus enabling more sophisticated heat sink or heat spreader designs without affecting the accuracy of the optical system. It provides a good thermal interface even in cases in which the heat sink or heat spreader is shifted with respect to the carrier of the LED module. In an advantageous embodiment the material of the member forming the thermal interface is furthermore selected such that the member adapts to the surface roughness of the heat sink or heat spreader.

In a preferred embodiment, the member forming the thermal interface is made of a material which is ductile during assembling and then gets rigid—or is made rigid, e. g. by curing—after assembling. To this end the member is preferably made of a one-time formable material which maintains its shape after the forming.

Examples of members or materials which may be used for the thermal interface of the proposed LED device are flexible metal materials, e.g. a metal mesh, in particular a copper mesh, solid foams or bulk materials that are cured after assembling, e.g. thermally conductive potting compounds, or constructions using a spring like component. With such a member the heat sink or heat spreader and the module or carrier with the one or several LEDs can be aligned once when assembling the whole system in order to adapt the LED device to the facility in which the device is to be mounted. The positioning of the heat sink versus the carrier with the LEDs is not defined by the LED module, but can be adjusted individually at this time.

The heat sink or heat spreader itself is preferably formed of a compact material, e.g. from a block of metallic material.

Applications of such a LED device with a LED module are lighting and signaling functions for automotive lamps, e. g. high beam, low beam, daytime running light, front turn indicator, front and rear fog or rear combination lamp. Nevertheless such an LED device may also be used in other applications which require a flexible overall design of the device.

### BRIEF DESCRIPTION OF THE DRAWINGS

The proposed LED device is described in the following by way of examples in connection with the accompanying figures. The figures show:

FIG. 1 a first example of a LED module on a heat sink according to the present invention;

FIG. 2 a second example of a LED module on a heat sink according to the present invention;

FIG. 3 a third example of a LED module on a heat sink according to the present invention;

FIG. 4 a fourth example of a LED module on a heat sink according to the present invention; and

FIG. 5 an example showing the assembling of a LED device according to the present invention in an automotive lamp from a) to d).

### DETAILED DESCRIPTION OF EMBODIMENTS

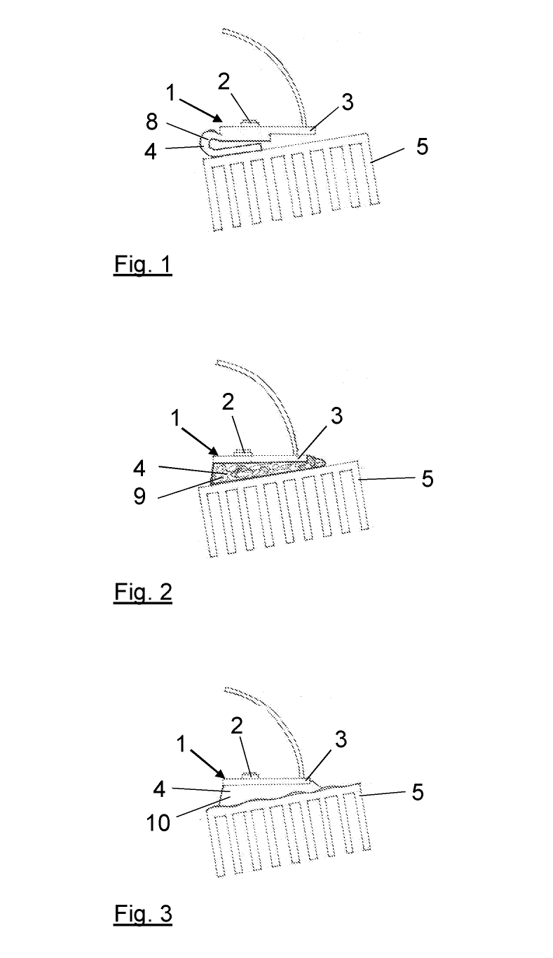

FIG. 1 shows a cross sectional schematic view of a first example of the proposed LED device in which the LED module 1 is thermally connected via a thermal interface 4 to a heat sink 5. Although not shown in the figures, such a LED module also comprises one or several electrical connection pads for electrically connecting the LEDs. In this example the thermal interface 4 is formed of a spring like metallic member 8 between the carrier 3 of the module 1, on which the LED 2 is mounted, and the heat sink 5. The use of such a spring like member 8 for the thermal interface 4 has the possibility to appropriately bend this member so that the carrier 3 and the heat sink 5 can be flexibly positioned and oriented to one another and still maintain a good thermal connection between one another.

The example of FIG. 2 shows a cross sectional schematic view of a second example in which a heat conductive metal mesh 9 is placed between the carrier 3 and the heat sink 5. This flexible mesh 9 allows an independent positioning and orienting of the module 1 or carrier 3 and the heat sink 5 from one another. The mesh 9 fills the volume between both components to achieve the appropriate thermal connection.

FIGS. 3 and 4 show further examples in which the thermal interface 4 is formed of a voluminous material, in particular a solid heat-conductive foam 10, which is ductile during the assembling of the device. The heat conductive ductile foam is placed between the carrier 3 and the heat sink 5 at the time of assembling. This also allows an independent positioning and orienting of the module 1 or carrier 3 and the heat sink 5 from one another. The foam fills the volume between both components to achieve the appropriate thermal connection. After applying the foam and adjusting both components as appropriate, the foam then gets rigid automatically or is cured, e. g. by UV curing, after assembling. As shown in FIGS. 3 and 4 such a foam adapts to the rough surface of the heat sink 5 due to its ductility at the time of application.

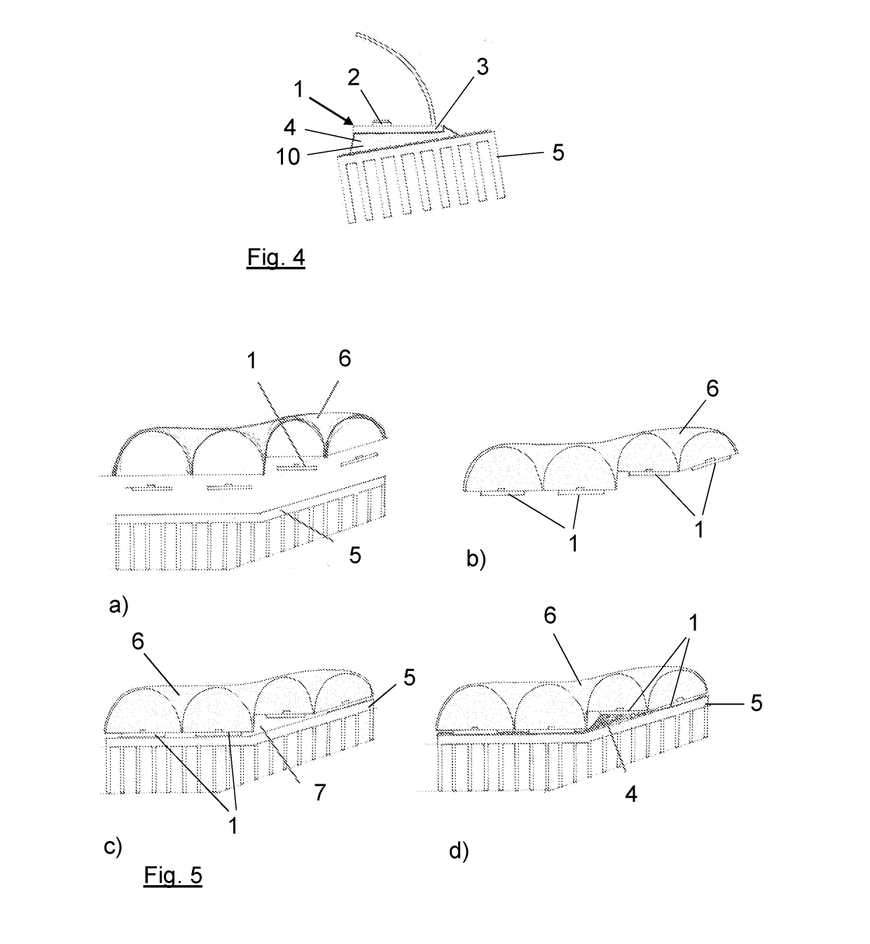

FIG. 5 shows an example of assembling four LED modules 1 in a reflector 6 of an automotive lamp. In this case, as shown in FIG. 5a, the four modules 1 formed of the carrier 3 and the LED 2 have to be mounted in the corresponding four reflector components. A common heat sink 5 has to be thermally connected to the four LED modules 1. The heat sink 5 has its own mechanical fixation and can be mounted independently from the mechanical fixation and references of the LED modules 1 in the reflector components. In FIG. 5b the mounting of the LED modules 1 to the reflector components are made for good optical referencing. After this mounting the heat sink 5 has to be connected to the LED modules 1. FIG. 5c shows the positioning of the heat sink 5 close to the LED modules 1. Without any further thermal interface, an air gap 7 would arise between one of the modules and the heat sink 5 as shown in FIG. 5c. Using the flexible thermal interface 4 according to the present invention, the heat sink 5 can be connected with good thermal connection to all LED modules 1 independent of the actual position and orientation of the heat sink 5 relative to the LED modules 1 as shown in FIG. 5d. The thermal interface 4 is formed only once, e. g. it will become rigid and maintain its position and shape after assembling of the automotive lamp in order to provide the thermal contact. As the heat sink alignment is separated from the mechanical referencing of the optical system to the LED modules 1, no compromise between styling freedom and thermal performance has to be made.

While the invention has been illustrated and described in detail in the drawings and forgoing description, such illustration and description are to be considered illustrative or exemplary and not restrictive. The invention is not limited to the disclosed embodiments. Other variations to the disclosed embodiments can be understood and effected by those skilled in the art in practicing the claimed invention, from a study of the drawings, the disclosure and the appended claims. In the claims the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the invention.

### LIST OF REFERENCE SIGNS

1 LED module
2 LED
3 carrier
4 thermal interface
5 heat sink
6 reflector
7 air gap
8 spring like metallic member
9 metal mesh
10 solid foam

1. A method for providing a LED device of flexible design, the LED device at least comprising a LED module with one or several light emitting diodes mounted on a carrier, a heat sink or heat spreader, and a thermal interface between the carrier and the heat sink or heat spreader, said carrier being thermally connected via the thermal interface to the heat sink or heat spreader,
the method comprising the steps of:
providing the one or several light emitting diodes and the carrier;
aligning the carrier and the one or several light emitting diodes according to an optical referencing of the LED device's design;
providing the heat sink or heat spreader in a form according to the LED device's design;
providing the thermal interface in the form of a member of a heat conducting material, which is ductile at least during assembling but maintains its position and shape after assembling; and
aligning and assembling the carrier and the heat sink or heat spreader by means of the thermal interface with the positions of the carrier and of the heat sink or heat spreader being determined independent from each other according to the LED device's design.

2. The method according to claim 1, characterized in that the member is formed of a material which gets rigid or is made rigid after assembling of the device.

3. The method according to claim 2, characterized in that the member is formed of a solid foam or a solid bulk material.

4. The method according to claim 1, characterized in that the member is formed of a flexible metal.

5. The method according to claim 4, characterized in that the member has a spring-like shape.

6. The method according to claim 1, characterized in that the member is formed of a metal mesh.

7. The method according to claim 1, characterized in that the heat sink or heat spreader is formed of a compact solid material.

8. The method according to claim 1, further comprising the steps of:
providing an optical system; and
integrating and aligning the optical system with the one or several light emitting diodes or the carrier.

9. (canceled)

10. The method according to claim 8, characterized in that the optical system includes one or more reflectors.

11-13. (canceled)
